(19) United States
(12) Patent Application Publication
(10) Pub. No.: US 2009/0263122 A1
(43) Pub. Date: Oct. 22, 2009

(54) Method and apparatus for network diagnostics in a passive optical network

(76) Inventors: Roger Jonathan Helkey, Montecito, CA (US); Volkan Kaman, Santa Barbara, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/148,913

(22) Filed: Apr. 22, 2008

(51) Int. Cl. H04B 10/00; H04J 14/00

(52) U.S. Cl. 398/7; 398/48

(57) ABSTRACT

A method and apparatus are described for allowing diagnostics of a Passive Optical Network without significant loss of service to active customer sites. A plurality of primary transmitters operating at a first wavelength band are coupled to an optical switch of an optical network operating at a first wavelength band. A backup transmitter operating at the first wavelength band is coupled to a first input of a wavelength division multiplexer. An optical device operating at a second wavelength band is coupled to a second input of the wavelength division multiplexer. An output of the wavelength division multiplexer is coupled to an input of the optical switch. Outputs of the optical switch are coupled to a plurality of optical splitters. Each splitter has a plurality of optical outputs. The optical switch is reconfigured such that one of the optical switch outputs that was carrying traffic from one of the primary transmitters carries traffic from the backup transmitter after reconfiguring the optical switch.

### FIELD

The present invention relates to optical networks, and more particularly to operation of a Passive Optical Network (“PON”).

### BACKGROUND

The bandwidth of customer network services continues to increase over time such that high bandwidth optical networks carry these customer services increasing closer to customer sites. The limiting case of this trend is Fiber To The Home (“FTTH”) networks, in which customer services are brought all the way to each home over optical fiber. Customer services delivered by fiber networks include telephone service, internet access, and video services.

One configuration for distributing high bandwidth customer services is a Passive Optical Network (“PON”), in which there are no active components deployed near customer sites. Active component are placed in a Central Office (“CO”), then data are distributed to customers using only passive elements between the Central Office and the customer. Some PON variants include Broadband PON (“BPON”), Gigabit PON (“GPON”), and Ethernet PON (“EPON”). The GPON standard is defined by ITU-T G.984.

The PON architecture is a low cost way of delivering high bandwidth signals to customers, but very restrictive with respect to allowed network changes because of multiple customers sharing the same optical network paths. In the event of a fiber cut to one customer, it is desirable to locate the fiber cut using an optical time domain reflectometer (“OTDR”). The OTDR sends an optical signal down the fiber. By looking at the signal return, one is able to determine the distance down the fiber to a fiber cut. The difficulty is that the PON architecture saves equipment cost by sharing the same service with N different customers, so disconnecting the PON transmitter in order to connect the OTDR also disconnects N−1 customers who have active service and would object to this interruption of service.

A prior art gigabit Passive Optical Network (“GPON)” network configuration 100 is shown in FIG. 1. In order to minimize the cost of the distribution network, data destined for a number of customers are combined using Optical Line Termination (“OLT”) transmitters 101a-101b. Each of the OLT transmitters 101a-101b transmits to the vicinity of a group of customers on a respective single optical fiber (fiber 121a for OLT transmitter 101a and fiber 121b for OLT transmitter 101b), then splits the signal into N identical versions using a 1:N optical splitter (splitter 123a for OLT transmitter 101a and splitter 123b for OLT transmitter 101b). Each customer receives the video signals for all N customers carried by single optical fiber (fiber 121a for OLT transmitter 101a and fiber 121b for OLT transmitter 101b). OLTs are available from a variety of vendors, including Alcatel of Paris, France and Motorola of Schaumberg, Ill. Customer services are extracted at each customer site using an Optical Network Unit (“ONU”) receiver, such as receivers 125a-125d, which extracts only the signals destined for that particular customer. ONUs are available from a variety of vendors, including Alcatel of Paris, France and Motorola of Schaumberg, Ill. There is also lower bandwidth traffic in the reverse direction from the customer back to the OLT that operates in analogous fashion to the forward going traffic.

The maximum optical splitter ratio N is determined principally by the allowed network signal-to-noise ratio, which is degraded by large optical splitter ratios and by the need to separate multiple subscriber signals at the customer site. A typical value of N might be 32, although much higher values of N are desired if possible, as higher values of splitter ratio N reduces the cost per customer of the PON network. Customer signals are transmitted using time division multiplexing (“TDM”), wherein timeslots in the transmitted waveforms are assigned to each customer site, and the ONU at each customer site allows access only to the customer services sent to that customer site. Each ONU requires some time to synchronize to the transmitted TDM signal in order to extract customer signals from the appropriate time slots. Resynchronization to the transmitted TDM signal is required if there is service disruption, such as a power outage, or failure of an OLT and replacement with a backup OLT.

### SUMMARY

An apparatus is described that includes an optical switch, an optical wavelength division multiplexer, a plurality of primary optical transmitters, a backup optical transmitter, a second optical device, and a plurality of optical splitters. The optical switch has a first input, a second plurality of inputs, and a plurality of outputs. The optical wavelength division multiplexer has at least two inputs and has an output. The output of optical wavelength divisional multiplexer is coupled to the first input of the optical switch. The plurality of primary optical transmitters are connected to the second plurality of inputs of the optical switch. A backup optical transmitter is connected to one input of the wavelength division multiplexer. A second optical device in connected to the second input of the wavelength division multiplexer. The second optical device operates at a different optical wavelength than a wavelength of the backup optical transmitter. The plurality of optical splitters are connected to the plurality of optical switch outputs. Each optical splitter has one or more inputs and a plurality of optical outputs.

A method is also described of adding an optical device with a second wavelength band to an optical transmission network operating at a first wavelength band. A plurality of primary transmitters operating at a first wavelength band are coupled to an optical switch of an optical network operating at a first wavelength band. A backup transmitter operating at the first wavelength band is coupled to a first input of a wavelength division multiplexer. An optical device operating at a second wavelength band is coupled to a second input of the wavelength division multiplexer. An output of the wavelength division multiplexer is coupled to an input of the optical switch. Outputs of the optical switch are coupled to a plurality of optical splitters. Each splitter has a plurality of optical outputs. The optical switch is reconfigured such that one of the optical switch outputs that was carrying traffic from one of the primary transmitters carries traffic from the backup transmitter after reconfiguring the optical switch.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements, and in which:

FIG. 1 shows a prior art passive optical network system.

FIG. 2 shows a passive optical network system in accordance with an embodiment of the invention.

### DETAILED DESCRIPTION

Embodiments of a method and apparatus are described for allowing diagnostics of a Passive Optical Network (“PON”) without significant loss of service to active customer sites. The described embodiments provide improved low-cost diagnostic capability that does not interrupt existing customer traffic. Embodiments of the described system provide an improved ability to upgrade customer service and substantially reduce repair time in the event of a failure in the Optical Line Termination (“OLT”) used to provide customer service. An embodiment of the system uses a backup OLT with a wavelength division multiplexer to allow injection of a signal at a secondary wavelength. For one embodiment, this signal at the secondary wavelength is generated by an Optical Time Domain Reflectometer (“OTDR”) in order to locate a possible fiber cut. For another embodiment, the signal at the secondary wavelength provides premium level customer service, such as operation at a higher bandwidth.

Embodiments of the disclosed system use an optical switch to allow replacement of the primary OLT signal that has no OTDR capability with a backup OLT signal having OTDR capability and/or delivery of premium customer service.

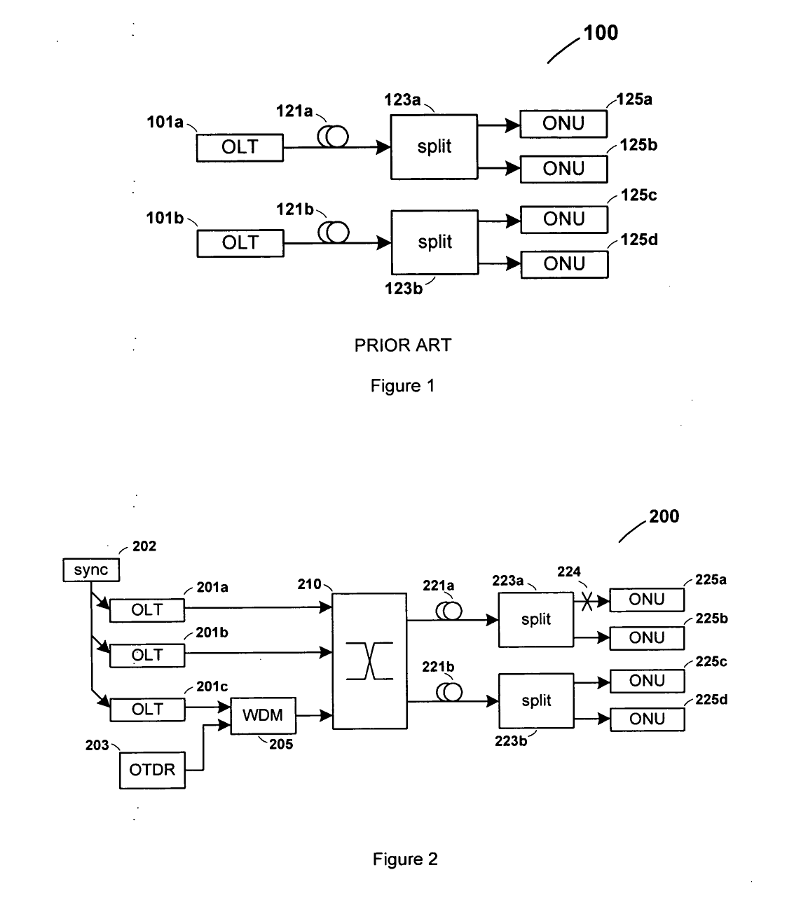

A passive optical network system 200 in accordance with an embodiment of the present invention is shown in FIG. 2. PON system 200 is what results from applying embodiments of the present invention to the prior art GPON network configuration 100 of FIG. 1. A plurality of OLTs 201a and 201b provide customer network services at a Central Office (“CO”). A typical Central Office might have five hundred OLTs servicing 16,000 customer sites. Each of the OLT's 201a and 201b is connected to optical switch 210 located at the Central Office.

The loss budget of the PON is very limited, so it is crucial that the optical switch 210 have low insertion loss. The PON network application is extremely cost sensitive, so the cost per port of optical switch 210 must be low. A typical central office has hundreds of OLTs, so an optical switch 210 with a large number of input and output ports is useful to interconnect each OLT with each corresponding distribution optical splitter and minimize the required number of backup OLTs. Optical switches that have large numbers of ports, low insertion loss, and low cost per port can be fabricated using MEMS mirrors that rotate in two axes, such as shown in U.S. Pat. No. 6,456,751. Large MEMS-based optical switches are available from Calient Networks of San Jose, Calif. and Glimmerglass of San Jose, Calif.

The optical signal from OLT 201a is carried from switch 210 by optical fiber 221a to optical splitter 223a located in a group of customer sites. Optical splitters are available from a number of sources such as ANDevices of Fremont, Calif. In a typical application, each of optical splitters 223a and 223b has a splitting ratio of 1:32, allowing each OLT to provide service to 32 customers. ONU 225a extracts customer services for a single customer from the optical data stream from OLT 201a, and provides a reverse data path back from the customer to OLT 201a. Similarly, the optical signal from OLT 201b is carried from switch 210 by optical fiber 221b to optical splitter 223b located in a group of customer sites. ONU 225c extracts customer services for a single customer from the optical data stream from OLT 201b and provides a reverse data path back from the customer to OLT 201b. ONUs 225b and 225d likewise extract services for customers from optical signals provided by respective OLTs 201a and 201b. ONUs 225b and 225d likewise provide reverse data paths back from customers to respective OLTs 201a and 201b.

OLT 201c is provided as a backup to the other OLTs. If OLT 201a fails, customer services are provided to customers serviced by ONU 225a and 225b by switching traffic from OLT 201c through optical switch 210 to splitter 223a. Similarly, if OLT 201b fails, customer services are provided to customer serviced by ONU 225c and 225d by switching traffic from OLT 201c through optical switch 210 to splitter 223b. If the failure of OLT 201a is detected before OLT 201a stops functioning, synchronizing circuit 202 can synchronize backup OLT 201c before the failover operation to avoid a short loss in service to the customers serviced by splitter 223a, including customers serviced by ONU 225a and ONU 225b. If the failure is sudden, however, some synchronization time will be required, as backup OLT 201c must be ready to back up any OLT 201a or 201b. For one embodiment, OLT 201a, OLT 201b, and OLT 201c are all synchronized to minimize synchronization time at failover.

Optical Time Domain Reflectometer (“OTDR”) 203 is used to diagnose fiber cuts in the PON. Signals from OTDR 203 are connected to switch 210 via wavelength division multiplexer (“WDM”) 205. Wavelength division multiplexer 205 provides low loss from OLT 201c to switch 210 at the OLT wavelength, and from OTDR 203 to switch 210 at the OTDR wavelength. OTDRs typically operate at a wavelength of 1625 nm. WDMs with the appropriate optical properties are available from JDSU of Milpitas, Calif.

If there is a fiber cut 224 between splitter 223a and ONU 225a, the PON detects loss of connectivity resulting in loss of customer services by one customer served by ONU 225a. OLT 201c is switched to splitter 223a after first synchronizing OLT 201c to OLT 201a using synchronizing circuit 202. If OLT 201c was not first synchronized to OLT 201a, there would be a short loss in service to the customer serviced by ONU 225b and the other customers serviced by splitter 223a. For example, if splitter 223a had a splitting ratio of 1:32, there would be one customer affected by fiber cut 224, but 31 customers affected for a short period of time after switching traffic from OLT 201a to OLT 201c until the 31 customer ONUs synchronized to the new OLT traffic.

Once network traffic is switched to OLT 201c, OTDR 203 measures the optical back reflection from fiber 221a and splitter 223a. Based on time-resolved measurement of optical back reflection, OTDR 203 is able to locate the distance between the fiber break 204 and splitter 223a. Using the distance from fiber break 204 and splitter 223a, together with mapping information collected by the service provider when laying these fibers, a repair operator is able to determine the approximate geographic location of fiber cut 204 and repair customer service to ONU 225a. OTDRs with sufficient dynamic range to operate with the high loss of an optical splitter are available from Sunrise Telecom of San Jose, Calif.

OTDR 203 can instead be another type of transmitter 203 for premium customer services—for example, high-definition video for which customers pay more. This method to switch traffic from one OLT 201a to a backup OLT 201c can also be used to upgrade services to a set of customers. For example, when a customer using ONU 225a to deliver standard services upgrades to premium services, all customers connected to splitter 223a are upgraded by switching from OLT 201a to OLT 201c to provide data. ONU 225b would then receive premium services from OLT 201c as ONU 225a, but ONU 225b would only distribute these services to the customer using ONU 225b if this customer also were paying for premium services.

For one embodiment, optical source 203 transmits another known test or instrumentation signal. For one embodiment, optical source 203 transmits both an OTDR signal or other known test signal and a premium customer service. For one embodiment, coupler 205 has multiple inputs at different wavelengths, for example a wavelength-independent input for premium customer services and a narrowband wavelength input for the OTDR or other test input.

In the foregoing specification, exemplary embodiments of the invention have been described. It will, however, be evident that various modifications and changes may be made thereto without departing from the broaden spirit and scope of the invention as set forth in the appended claims. The specification and drawings are, accordingly, to be regarded in an illustrative rather than a restrictive sense.

What is claimed is:

1. An apparatus comprising:
an optical switch having a first input, a second plurality of inputs, and a plurality of outputs;
an optical wavelength division multiplexer having at least two inputs and with an output, wherein the output of the optical wavelength division multiplexer is coupled to the first input of the optical switch;
a plurality of primary optical transmitters connected to the second plurality of inputs of the optical switch;
a backup optical transmitter connected to one input of the wavelength division multiplexer;
a second optical device connected to the second input of the wavelength division multiplexer, wherein the second optical device operates at a different optical wavelength than a wavelength of the backup optical transmitter;
a plurality of optical splitters connected to the plurality of optical switch outputs, wherein each optical splitter has one or more inputs and a plurality of optical outputs.

2. The apparatus of claim 1, further comprising a synchronizing device that synchronizes the backup optical transmitter with at least one of the plurality of primary optical transmitters.

3. The apparatus of claim 2, wherein the optical switch is used to switch an optical splitter input from being connected to the primary optical transmitters to being connected to the backup optical transmitter.

4. The apparatus of claim 1, where the primary optical transmitters comprise Optical Line Terminals that each distributes multiple sets of data signals to multiple customers.

5. The apparatus of claim 1, further comprising Optical Network Unit receivers, wherein each Optical Network Unit receiver extracts one or more sets of data signals transmitted by an Optical Line Terminal.

6. The apparatus of claim 1, wherein the second optical device comprises an optical time domain reflectometer.

7. The apparatus of claim 1, wherein the second optical device transmits alternate services to one or more Optical Network Units.

8. A method comprising:
coupling a plurality of primary transmitters operating at a first wavelength band to a plurality of inputs of an optical switch of an optical network operating at a first wavelength band;
coupling a backup transmitter operating at the first band to one input of a wavelength division multiplexer;
coupling an optical device operating at a second wavelength band to a second input of the wavelength division multiplexer;
coupling an output of the wavelength division multiplexer to an input of the optical switch;
coupling outputs of the optical switch to a plurality of optical splitters, each splitter having a plurality of optical outputs;
reconfiguring the optical switch such that one of the optical switch outputs that was carrying traffic from one of the primary transmitters carries traffic from the backup transmitter after reconfiguring the optical switch.

9. The method of claim 8, further comprising synchronizing an output of the backup transmitter to an output of one of the primary transmitters before reconfiguring the optical switch.

10. The method of claim 8, further comprising testing the optical transmission network using an optical time domain reflectometer.

11. The method of claim 8, further comprising sending network traffic in the second wavelength band through one of the plurality of optical splitters.

12. The method of claim 8, wherein the primary optical transmitters comprise Optical Line Terminals wherein each Optical Line Terminal distributes multiple sets of data signals to multiple customers.

13. The method of claim 8, further comprising having Optical Network Units extract one or more sets of data signals transmitted by the Optical Line Terminals.

14. The method of claim 13, wherein the second optical device transmits additional data to at least one of the Optical Network Units.

15. The method of claim 14, wherein the additional data comprises high-definition video.
